(19) United States
(12) Patent Application Publication
(10) Pub. No.: US 2021/0042759 A1
(43) Pub. Date: Feb. 11, 2021

(54) INCREMENTAL ENROLMENT ALGORITHM

(71) Applicant: ZWIPE AS, Oslo (NO)

(72) Inventors: Steffen LARSEN, Oslo (NO); Pascal DUFOUR, Les Sables-d'Olonne (FR)

(21) Appl. No.: 16/618,948

(22) PCT Filed: Jun. 18, 2018
(86) PCT No.: PCT/EP2018/066075

§ 371 Date: Dec. 3, 2019

(30) Foreign Application Priority Data
Jun. 19, 2017 (GB) 1709748.6

(51) Int. Cl. G06Q 20/40; G06Q 20/34; G06F 21/32

(52) U.S. Cl. CPC G06Q 20/40145; G06F 21/32; G06Q 20/34; G06Q 20/4012

(57) ABSTRACT

A method of incrementally enrolling a user's fingerprint onto a payment card includes authorising a predetermined number of transactions using the payment card with a non-biometric verification, such as a PIN, where the user presents their finger to an onboard biometric sensor of the payment card during each authorisation, and then generating a biometric template for the user's fingerprint using fingerprint data collected from each of the authorisations.

The present invention relates to the enrolment of a biometric template onto a biometrically-authorised device, such as a smartcard.

Smartcards are becoming increasingly more widely used and include, for example access cards, credit cards, debit cards, pre-pay cards, loyalty cards, identity cards, and so on. Smartcards are electronic cards with the ability to store data and to interact with the user and/or with outside devices, for example via contactless technologies such as RFID. These cards can interact with readers to communicate information in order to enable access, to authorise transactions and so on.

More recently, biometric authorisation such as fingerprint authorisation is being implemented on smartcards. Smartcards with biometric authorisation can interact with the user via sensors in order to enable access to secure features of the smartcard, for example in order to authorise financial transactions.

A biometrically-authorised smartcard can usually operate in either a biometric verification mode, where the user is identified by presenting a biometric identifier, or in a non-biometric mode, where the user is identified using non-biometric means, such as by entering a PIN (personal identification number) into a corresponding terminal.

Before the smartcard may be used in the biometric verification mode, it is necessary for the user to enrol their biometric identifier onto the smartcard. However, if the recipient of a “virgin” smartcard is simply permitted to enrol their biometric identifier, then an unauthorised person who has intercepted delivery of the smartcard could enrol their own biometric identifier and fraudulently use the smartcard.

One suggestion to overcome this problem has been to pre-load a biometric template onto the smartcard before sending it to the user. However, this requires a centralised database of users' biometric template, which raises privacy concerns as the security of the database could be compromised.

Another suggestion is that the user might be permitted only to enrol their biometric data in the presence of an authorised individual, such as in a bank or similar institution. However, this requires additional training of staff as well as inconveniencing the recipient of the smartcard.

Viewed from a first aspect, the present invention provides a method of enrolling a biometric identifier onto a device having an onboard biometric sensor, the method comprising: authorising a plurality of actions using the device without using biometric verification, wherein for each authorisation a bearer of the device presents a biometric identifier to the biometric sensor for generating biometric data; and generating a biometric template using the biometric data from each of the authorisations. The device may be a payment card, but other devices are envisaged within the scope of the disclosure.

In accordance with the described method, the user's biometric data is gradually enrolled onto the device as it is used. Eventually, e.g. after sufficient scans have been made, the biometric template is generated and the users biometric data is enrolled. This advantageously means that no additional infrastructure is required for secure enrolment of the user's biometric identifier. However, the process is still secure to a level appropriate for the device because it is being used to authorise actions. Thus, an intercepted, non-enrolled biometric device still cannot be used by an unauthorised person.

For each authorisation, the bearer of the device preferably simultaneously presents their biometric identifier to the biometric sensor to generate the biometric data, for example the user may present their biometric identifier whilst the non-biometric verification is taking place.

After generating the biometric template, preferably one or more actions may be authorised using the device in combination with a biometric verification without the non-biometric verification. The biometric validation may comprise comparing the biometric template with biometric data output by the biometric sensor.

The biometric verification is preferably performed on the device, e.g. such that the biometric template and/or the biometric data representing the biometric identifier presented to the biometric sensor are not transmitted off of the device for the verification.

At least one of the plurality of actions authorised using the device without using biometric verification preferably comprises authorising the action using the device in combination with a non-biometric verification. For example, the non-biometric verification comprises verifying a password supplied by a user of the device, such as a personal identification number (PIN). The non-biometric verification is preferably performed on the device.

Generated biometric data may be stored in a memory of the device after each (successful) authorisation. In some embodiments, the biometric template may be built up successively by combining the biometric data in the memory after each scan. In other embodiment, the biometric data may be collected and combined only after all of the necessary biometric data has been collected.

Biometric data is preferably not generated and/or stored on the device when the non-biometric validation is unsuccessful. If biometric data is generated and stored when a non-biometric validation is unsuccessful, this data is preferably not used for generating a biometric template.

The biometric template is generated only after one or more predetermined criteria are satisfied.

The predetermined criteria may comprise authorisation of a predetermined minimum number of actions where biometric data was simultaneously generated.

The predetermined criteria may comprise authorisation of a predetermined minimum number of different actions where biometric data was simultaneously generated.

The predetermined criteria may comprise capture of sufficient biometric data to generate a template covering at least a predetermined area of the biometric identifier

The predetermined criteria may comprise expiry of a predetermined period of time, such as a predetermined period of time since the first action was authorised and/or a predetermined period of time since delivery of the device to a user.

In one embodiment, the action comprises a financial transaction.

In another embodiment, the action comprises permitting access to a secure location. The secure location may be a physical location, such as a room within a building for example, or the location may be a virtual location, such as accessing data stored on a computer.

The action may be authorised by transmission of data from the device to a system external of the device The data may be transmitted by a contact interface or by a wireless interface

In preferred embodiments, the biometric identifier is a fingerprint

The device may be any biometric authorisation device. That is to say, a device comprising an onboard biometric sensor for authorising one or more actions external to the device. Examples include smartcards, car key fobs, mobile phones, tablet computers, other computing devices, etc. In preferred embodiments, the device is a smartcard. For example, the smartcard may be any one of an access card, a payment card (such as a credit card, a debit card or a pre-pay card), a loyalty card and an identity card.

Viewed from a second aspect, the present invention provides an authorisation device for authorising an action responsive to verification of the identity of a bearer of the device, the device comprising an onboard biometric sensor, wherein the device is configured to record biometric data collected by the biometric sensor when the device authorises actions without using biometric verification, and wherein the device is configured to generate a biometric template using the biometric data collected when the device authorises actions without using biometric verification. The authorisation device may be a payment card, but other devices are envisaged within the scope of the disclosure.

The device may be configured to require the bearer to presents a biometric identifier to the biometric sensor in order to perform the non-biometric verification. The device may be configured to perform a biometric verification to authorise one or more actions after generating the biometric template, which is preferably performed without requiring a non-biometric verification.

The biometric validation may comprise comparing the biometric template with biometric data from the biometric sensor. The device is preferably configured to perform the biometric verification on this device, e.g. such that the biometric template and/or the biometric data representing the biometric identifier presented to the biometric sensor are not transmitted off of the device.

The device may be configured to perform a non-biometric verification to verify the identity of the bearer of the device without using biometric verification. The non-biometric verification is performed on the device. The non-biometric verification may comprise verification of a password (e.g. a PIN) by the device.

The device preferably comprises a memory and the collected biometric data and/or biometric template may be stored in the memory (e.g. after each authorisation). The biometric data and/or biometric template may be stored in the memory at least until the biometric template is completed.

The device is preferably configured such that biometric data generated when the non-biometric validation is unsuccessful is not used for generating a biometric template. For example, biometric data may not be generated and/or stored on the device when the non-biometric validation is unsuccessful.

The device may be configured to generate the biometric template and/or used the biometric template for biometric verification only after one or more predetermined criteria are satisfied.

The predetermined criteria may comprise authorisation of a predetermined minimum number of actions where biometric data was simultaneously generated.

The predetermined criteria comprise authorisation of a predetermined minimum number of different actions where biometric data was simultaneously generated.

The predetermined criteria comprise capture of sufficient biometric data to generate a template covering at least a predetermined area of the biometric identifier

The predetermined criteria comprise expiry of a predetermined period of time, such as a predetermined period of time since the first action was authorised and/or a predetermined period of time since delivery of the device to a user. The action comprises a financial transaction or the action may comprise permitting access to a secure location.

The device is configured to transmit data to a system external of the device to authorise the action. The data may be transmitted by a contact interface or by a wireless interface

The biometric identifier is preferably a fingerprint

The device is a preferably smartcard. More specifically, the smartcard is one of an access card, a payment card (such as a credit card, a debit card or a pre-pay card), a loyalty card and an identity card.

Certain preferred embodiments of the present invention will now be described in greater detail, by way of example only and with reference to the accompanying drawings, in which:

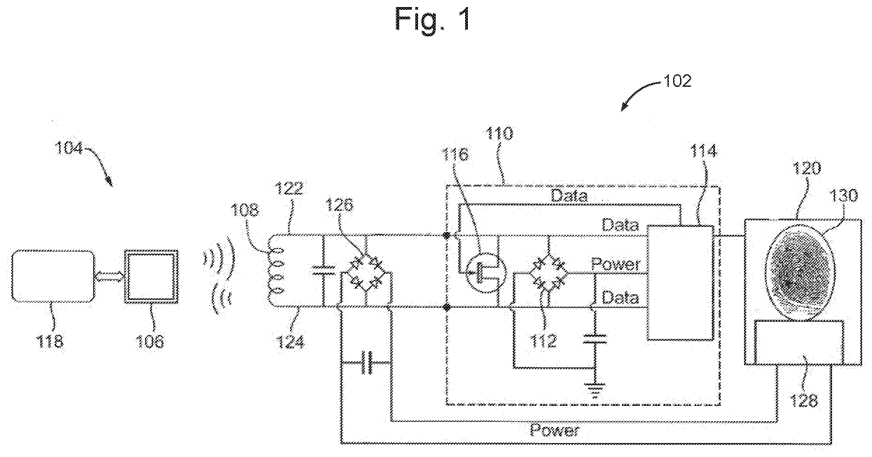

FIG. 1 is a diagram of a circuit for a smartcard incorporating a biometric sensor in the form of a fingerprint area sensor;

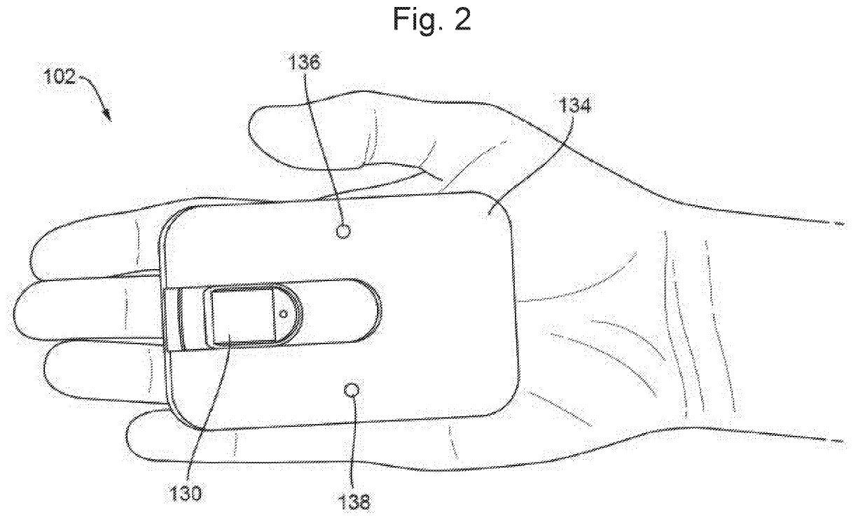

FIG. 2 illustrates a smartcard with an external housing; and

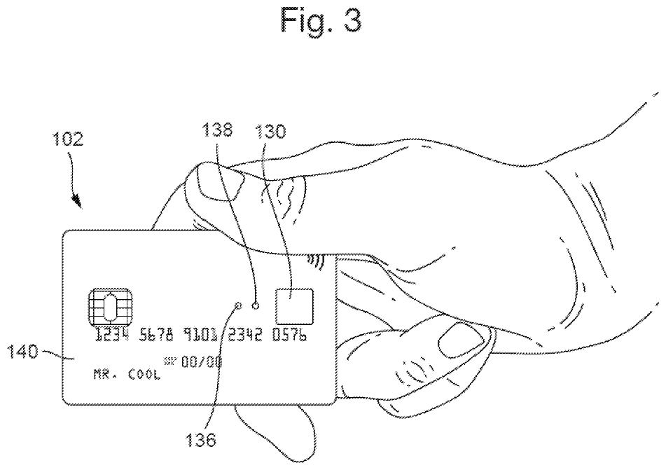

FIG. 3 shows a laminated type smartcard.

By way of example the invention is described in the context of a smartcard that uses contactless technology and, in the illustrated embodiment, uses power harvested from the reader. These features are envisaged to be advantageous features of the proposed system, but are not seen as essential features. The smartcard may hence alternatively use a physical contact and/or include a battery providing internal power, for example. In further embodiment, the technology may be incorporated into other biometric authorisation devices, i.e. devices comprising an onboard biometric sensor for authorising one or more actions external to the device, such as car key fobs, mobile phones, etc.

FIG. 1 shows the architecture of a smartcard 102. A powered card reader 104 transmits a signal via an antenna 106. The signal is typically 13.56 MHz for MIFARE® and DESFire® systems, manufactured by NXP Semiconductors, but may be 125 kHz for lower frequency PROX® products, manufactured by HID Global Corp. This signal is received by an antenna 108 of the smartcard 102, comprising a tuned coil and capacitor, and then passed to a communication chip 110. The received signal is rectified by a bridge rectifier 112, and the DC output of the rectifier 112 is provided to a smartcard processor 114 that controls the messaging from the communication chip 110.

A control signal output from the smartcard processor 114 controls a field effect transistor 116 that is connected across the antenna 108. By switching on and off the transistor 116, a signal can be transmitted by the smartcard 102 and decoded by suitable control circuits 118 in the reader 104. This type of signalling is known as backscatter modulation and is characterised by the fact that the reader 104 is used to power the return message to itself.

A fingerprint authentication engine 120 is connected to the smartcard processor 114 in order to allow for biometric authentication of the user based on a finger or thumb print. The fingerprint authentication engine 120 can be powered by the antenna 108 so that the card is a fully passive smartcard 102. In that case the fingerprint identification of an authorised user is only possible whilst power is being harvested from the card reader 104. In an alternative arrangement the smartcard 102 may be additionally provided with a battery (not shown in the Figures) allowing for the fingerprint authentication engine 120, and also the related functionalities of the smartcard processor 114 to be used at any time.

As used herein, the term “passive smartcard” should be understood to mean a smartcard 102 in which the communication chip 110 is powered only by energy harvested from an excitation field, for example generated by the card reader 118. That is to say, a passive smartcard 102 relies on the reader 118 to supply its power for broadcasting. A passive smartcard 102 would not normally include a battery, although a battery may be included to power auxiliary components of the circuit (but not to broadcast); such devices are often referred to as “semi-passive devices”.

Similarly, the term “passive fingerprint/biometric authentication engine” should be understood to mean a fingerprint/biometric authentication engine that is powered only by energy harvested from an excitation field, for example the RF excitation field generated by the card reader 118.

It should be noted that in alternative embodiments battery powered and hence non-passive smartcards may be provided and may have the same features in relation to the fingerprint sensor, enrolment process, authentication process, and so on. With these alternatives the smartcard can have the same features aside from that the use of harvested power is replaced by the power from a battery that is contained within the card body.

The card body can be a card housing 134 as shown in FIG. 2 or a laminated card body 140 as shown in FIG. 3.

The antenna 108 comprises a tuned circuit including an induction coil and a capacitor, which are tuned to receive an RF signal from the card reader 104. When exposed to the excitation field generated by the reader 104, a voltage is induced across the antenna 108.

The antenna 108 has first and second end output lines 122, 124, one at each end of the antenna 108. The output lines of the antenna 108 are connected to the fingerprint authentication engine 120 to provide power to the fingerprint authentication engine 120. In this arrangement, a rectifier 126 is provided to rectify the AC voltage received by the antenna 108. The rectified DC voltage is smoothed using a smoothing capacitor and supplied to the fingerprint authentication engine 120.

The fingerprint authentication engine 120 includes a fingerprint processor 128 and a fingerprint reader 130, which can be an area fingerprint reader 130, mounted on a card housing 134 as shown in FIG. 2 or fitted so as to be exposed from a laminated card body 140 as shown in FIG. 3. The card housing 134 or the laminated body 140 encases all of the components of FIG. 1, and is sized similarly to conventional smartcards. The fingerprint authentication engine 120 can be passive and hence powered only by the voltage output from the antenna 108, or there may be battery power as mentioned above. The fingerprint processor 128 comprises a microprocessor that is chosen to be of very low power and very high speed, so as to be able to perform biometric matching in a reasonable time.

When performing a biometric verification, the fingerprint authentication engine 120 is arranged to scan a finger or thumb presented to the fingerprint reader 130 and to compare the scanned fingerprint of the finger or thumb to pre-stored fingerprint data using the fingerprint processor 128. A determination is then made as to whether the scanned fingerprint matches the pre-stored fingerprint data. In a preferred embodiment, the time required for capturing a fingerprint image and authenticating the bearer of the card 102 is less than one second.

If a fingerprint match is determined, then the processor 128 takes appropriate action depending on its programming. In this example the fingerprint authorisation sends a signal to the communication chip 110 to authorise the smartcard processor 114 to transmit a signal to the card reader 104 when a fingerprint match is made. The communication chip 110 transmits the signal by backscatter modulation, in the manner described above.

The card 102 may provide an indication of successful authorisation using a suitable indicator, such as a first LED 136, or by making an audible output from the speaker 134.

The smartcard 102 has an enrolment mode, which may be initially active when the smartcard 102 is supplied to a user. That is to say, before a biometric template has been loaded onto the smartcard 102. In the enrolment mode, the smartcard 102 will not authorise transactions using just a biometric verification of the user, but instead requires a non-biometric verification to be used. Non-biometric verification technology that can be performed electronically on the smartcard 102 is well known in the art. In the following example, personal identification number (PIN) verification will be described, but this is merely one example.

In the enrolment mode, when a user wishes to use the smartcard 102 to authorise an action, the user presents their smartcard 102 to a terminal and is prompted to enter a PIN. This is transmitted from the terminal to the smartcard 102 where it is verified by the smartcard processor 114 and, if the PIN matches a stored value on the smartcard 102, then the smartcard 102 transmits data back to the terminal to authorise the action.

Each time the smartcard 102 authorises, the user is prompted to present their finger to the fingerprint sensor 120. In some embodiments, the card may not authorise the action until the user has presented their finger, even though the verification is not based on this. In other embodiment, this may be optional, for example the user may be prompted to present their finger.

The user may be required to present their finger for a predetermined minimum period of time or until a clear scan has been made. This may, for example, be indicated using indicators 136, 138 on the smartcard 102.

Preferably the smartcard processor 114 provides an indication to the fingerprint authentication engine 120 regarding whether or not the non-biometric verification was successful or not. Thus, if the verification was unsuccessful, then the fingerprint authentication engine 120 can either not activate or may not store the biometric data scanned. Alternatively, the engine 120 may still scan and store the fingerprint data, but may mark it as an unverified scan and then only use it after checking it against a template assembled of other verified scans, e.g. to provide supplementary data points.

Each time the user scans their fingerprint, biometric data is extracted from the fingerprint and stored in a memory of the fingerprint authentication engine 128. After a number of fingerprint scans, the biometric data from each of the scans is processed and combined to generate a biometric template. Consequently, the user is gradually enrolled gradually over a period of time.

Once successful enrolment occurs, the relevant function of the smartcard 102 will be enabled. For example, in the case of a financial card, a secure element will authorise transactions using only the fingerprint verification to verify the identity of the bearer, e.g. without requiring a PIN. The user may be alerted to successful biometric enrolment using the indicators 136, 138 on the smartcard 102.

This enrolment technique does not require any additional infrastructure for the card issuer, e.g. specially trained personnel or a special terminal where the user can verify their identity using the PIN before performing multiple of scans to enrol their biometric data. However, because the biometric template is still generated from biometric data sampled only when the users identity has been verified, it is difficult for an unauthorised person to fraudulently enrol their data onto an intercepted smartcard 102.

In some embodiments, not all scans of the fingerprint need to simultaneously accompany a non-biometric verification. However, each scan should preferably accompany authorisation of an action. For example, in the case of contactless payment using a smartcard, entering the PIN may authorise the smartcard 102 to perform a predetermined number of small payments (e.g. five). The smartcard 102 may record biometric data for each of these payments even though a new non-biometric verification is not carried out for each authorisation. That is to say, a similar level of security may be applied to verification for enrolment purposes as is applied to verification for authorisation purposes.

The smartcard 102 may determine when to generate the biometric templates based on a number of criteria. These may include any one or more of the following.

The smartcard 102 may require that a predetermined minimum number of biometric data samples have been collected. For example the smartcard may require biometric data to have been collected from five separate scans of the finger.

The smartcard 102 may require that the captured biometric data contains sufficient biometric data to generate a template covering at least a predetermined area of the fingerprint. For example, the fingerprint may be smaller than the entire surface of the finger and so may capture only part of the fingerprint on each scan. Thus, the smartcard 102 may not generate the template if a significant portion of the fingerprint has not yet been scanned in any of the biometric data.

The smartcard 102 may require expiry of a predetermined period of time before generating the template. For example, the predetermined period may be a period of time since the smartcard 102 was first used to authorise action, or it may be a predetermined period of time since delivery of the smartcard 102 to the smartcard bearer.

The smartcard 102 may require a predetermined minimum number of non-biometric authorisations to have taken place. For example, the smartcard may require at least five transactions to have been separately authorised by non-biometric verification.

The smartcard 102 may require that a predetermined minimum number of different actions have been authorised by the smartcard 102 using non-biometric verification.

We claim:

1. A method of enrolling a biometric identifier onto a payment card having an onboard biometric sensor, the method comprising:
authorising a plurality of transactions using the payment card without using biometric verification, wherein for each authorisation a bearer of the payment card presents a biometric identifier to the biometric sensor for generating biometric data; and
generating a biometric template using the biometric data from each of the authorisations.

2. A method according to claim 1, further comprising:
after generating the biometric template, authorising one or more transactions using the payment card in combination with a biometric verification.

3. A method according to claim 2, wherein the biometric verification is performed on the payment card.

4. A method according to claim 1, wherein at least one of the plurality of transactions authorised without using biometric verification comprises authorising the transaction using the payment card in combination with a non-biometric verification.

5. A method according to claim 4, wherein the non-biometric verification comprises verifying a password supplied by a bearer of the payment card.

6. A method according to claim 1, wherein generated biometric data is stored in a memory of the payment card after each successful authorisation.

7. A method according to claim 6, wherein biometric data generated when a non-biometric validation is unsuccessful is not used for generating the biometric template, or wherein biometric data is not generated and/or stored on the payment card when a non-biometric validation is unsuccessful.

8. A method according to claim 1, wherein the biometric template is generated and/or used for biometric verification only after one or more predetermined criteria are satisfied.

9. A method according to claim 8, wherein the predetermined criteria comprise generation of a predetermined minimum number of biometric data samples.

10. A method according to claim 8, wherein the predetermined criteria comprise capture of sufficient biometric data to generate a biometric template covering at least a predetermined area of the biometric identifier.

11. A method according to claim 1, wherein the biometric identifier is a fingerprint.

12. An payment card for authorising a transaction after verification of the identity of a bearer of the payment card, the payment card comprising an onboard biometric sensor, wherein the payment card is configured to record biometric data collected by the biometric sensor when the payment card authorises transactions without using biometric verification, and wherein the payment card is configured to generate a biometric template using the biometric data collected when the payment card authorises transactions without using biometric verification.

13. A payment card according to claim 12, wherein the payment card is configured to require the bearer to present a biometric identifier to the biometric sensor before authorising an action without using biometric verification.

14. A payment card according to claim 12, wherein the payment card is configured to perform a biometric verification to authorise one or more transactions after generating the biometric template.

15. A payment card according to claim 12, wherein the payment card comprises a memory and the payment card is configured to store the biometric data and/or biometric template in the memory at least until the biometric template is complete.

16. A payment card according to claim 12, wherein the biometric identifier is a fingerprint.
